(19) United States
(12) Patent Application Publication
(10) Pub. No.: US 2016/0010978 A1
(43) Pub. Date: Jan. 14, 2016

(54) MEASUREMENT APPARATUS AND MEASURING METHOD

(71) Applicant: CANON KABUSHIKI KAISHA, Tokyo (JP)

(72) Inventor: Takeaki Itsuji, Hiratsuka-shi (JP)

(21) Appl. No.: 14/790,542

(22) Filed: Jul. 2, 2015

(30) Foreign Application Priority Data
Jul. 9, 2014 (JP) 2014-141807
May 26, 2015 (JP) 2015-106773

(51) Int. Cl. G01B 11/22

(52) U.S. Cl. CPC G01B 11/22

(57) ABSTRACT

A measurement apparatus may include: an irradiating unit configured to shape at least one terahertz wave and irradiate first and second surfaces of the object with the at least one shaped terahertz wave; a positional information acquiring unit configured to acquire positional information on a measurement area of the at least one shaped terahertz wave; and a position adjusting unit configured to relatively adjust a converging position of the at least one shaped terahertz wave and a position of the object in a depth direction of the object on a basis of the acquired positional information, which may be acquired by using relationship information indicating a relationship between positions of the first and second surfaces and intensities or beam propagation shapes of at least one first pulse and at least one second pulse of the at least one terahertz wave reflected respectively from the first and second surfaces.

### BACKGROUND OF THE INVENTION

1. Field of the Invention

This disclosure relates to at least one measurement apparatus configured to measure a time waveform of a terahertz wave, at least one measuring method thereof, and at least one imaging apparatus.

2. Description of the Related Art

A terahertz wave is typically an electromagnetic wave having a component falling within a given frequency band in a range from 0.03 THz to 30 THz. A spectroscopy using a terahertz time domain spectroscopy (THz-TDS) is known. This is a method of measuring the time waveform of the terahertz wave by detecting the terahertz wave while changing a time point when an ultrashort pulse reaches a detector.

In a case of acquiring information such as physical properties of a sample from a time waveform of the terahertz wave, a signal of the terahertz wave reflected from a reference surface as a reference (reference signal) and a signal of the terahertz wave reflected from a measurement surface of the sample (measurement signal) are acquired. Then, information on the sample is obtained from a change of the measurement signal with respect to the reference signal.

The time waveforms of the terahertz waves acquired respectively from the reference signal and the measurement signal include not only information on an intensity change of the terahertz wave, but also information on a phase change, and hence a positional displacement between the reference surface and the measurement surface in a depth direction affects the accuracy of acquisition of information on the sample. Accordingly, Japanese Patent Laid-Open No. 2004-198250 discloses a method of using as a reference signal a terahertz wave reflected from a reference surface which is a surface where the terahertz wave first reaches the parallel flat plate sample and as a measurement signal a terahertz wave reflected from a measurement surface which is a surface from which acquisition of information is desired, respectively. In this method, an influence of the positional displacement is suppressed by fixing the position of the measurement surface with respect to the reference surface by using the shape of the sample.

In the case where the position of the reference surface and the position of the measurement surface are different from each other in the depth direction, the states of the terahertz waves with which the respective surfaces are irradiated are also different from each other. For example, beam diameters of the terahertz waves to be radiated to the respective surfaces are different in the strict sense. Therefore, the time waveforms of the terahertz waves may include the influence due to difference in the states of the terahertz waves superimposed on the information of the reference surface and the measurement surface. Accordingly, intensities of the terahertz waves from the reference surface and the measurement surface and time difference in clock times of detection may vary depending on the states of the terahertz waves. Consequently, acquired information on the measurement surface may include difference in the state of the terahertz wave.

US2013/0334421 discloses a method of suppressing the influence of difference in the states of the terahertz waves, specifically, suppressing variations in time difference between clock times when time waveforms of terahertz waves reflected respectively from the reference surface and the measurement surface are detected. Specifically, accuracy of measurement of the time waveforms is improved by arranging the reference surface and the measurement surface within an area in which the time difference between the clock time when the terahertz wave from the reference surface is detected and the clock time when the terahertz wave from the measurement surface is detected become constant. By adjusting the position of the reference surface and the position of the measurement surface in the depth direction, measurement accuracy of the time waveforms of the terahertz waves is improved and hence accuracy of acquisition of the information on the measurement surface is improved.

In the case where measurement of the time waveform with higher accuracy is desired for medical diagnosis or the like, a reduction of the influence of difference in the states of the terahertz waves generated by the positional difference in the depth direction is required.

### SUMMARY OF THE INVENTION

At least one measurement apparatus according to an aspect of this disclosure is configured to irradiate an object to be measured with terahertz wave and measure a time waveform of the terahertz wave reflected from the object to be measured and includes: an irradiating unit configured to shape the terahertz wave and irradiate a first surface of the object to be measured and a second surface of the object to be measured with the shaped terahertz wave; a positional information acquiring unit configured to acquire positional information relating to or on a measurement area of the terahertz wave shaped in the irradiating unit; and a position adjusting unit configured to relatively adjust a converging position of the terahertz wave shaped in the irradiating unit and a position of the object to be measured in a depth direction of the object to be measured on a basis of the positional information relating to or on the measurement area acquired by the positional information acquiring unit. In at least one embodiment, the positional information acquiring unit acquires the positional information relating to or on the measurement area by using relationship information indicating a relationship between positions of the first and second surfaces of the object to be measured in the depth direction adjusted by the position adjusting unit and intensities or beam propagation shapes of the terahertz wave reflected respectively from the first and second surfaces of the object.

According to other aspects of the present inventions, one or more additional measurement apparatuses, at least one imaging apparatus and measuring methods are discussed herein. Further features of the present inventions will become apparent from the following description of exemplary embodiments with reference to the attached drawings.

### BRIEF DESCRIPTION OF THE DRAWINGS

FIG. 1A is an explanatory drawing illustrating a configuration of a measurement apparatus of a first embodiment.

FIG. 1B is an explanatory drawing illustrating a state in which the terahertz wave is shaped.

FIG. 2 is an explanatory drawing illustrating relationship information of the first embodiment.

FIG. 3 is a flowchart of a measuring method of the first embodiment.

FIG. 4 is an explanatory drawing illustrating a configuration of a measurement apparatus of a second embodiment.

FIG. 5 is a flowchart of a measuring method of a fifth embodiment.

FIG. 6 is an explanatory drawing illustrating relationship information of the second embodiment.

FIG. 7 is a flowchart of a measuring method of the second embodiment.

FIG. 8 is a flowchart of a measuring method of a fourth embodiment.

FIG. 9 is an explanatory drawing illustrating a configuration of a measurement apparatus of a third embodiment.

FIG. 10 is an explanatory drawing illustrating a relationship between a distance between a first surface and a second surface and measurement accuracy of the third embodiment.

FIG. 11A is an explanatory drawing illustrating a configuration of a first modification of members of a sixth embodiment.

FIG. 11B is an explanatory drawing illustrating a configuration of a second modification of the members of the sixth embodiment.

FIG. 11C is an explanatory drawing illustrating a configuration of a third modification of the members of the sixth embodiment.

FIG. 11D is an explanatory drawing illustrating a configuration of a fourth modification of the members of the sixth embodiment.

FIG. 12 is an explanatory drawing illustrating a member for acquiring a beam diameter of the first embodiment.

FIG. 13 is a flowchart of a measuring method of the third embodiment.

FIG. 14A is an explanatory drawing illustrating a configuration of an imaging apparatus of a seventh embodiment.

FIG. 14B is an enlarged drawing illustrating a periphery of a sample of the seventh embodiment.

FIG. 15 is a flowchart of a method of acquiring a measurement area of the second embodiment.

FIG. 16 is a flowchart of an image acquiring method of the imaging apparatus of the seventh embodiment.

### DESCRIPTION OF THE EMBODIMENTS

### First Embodiment

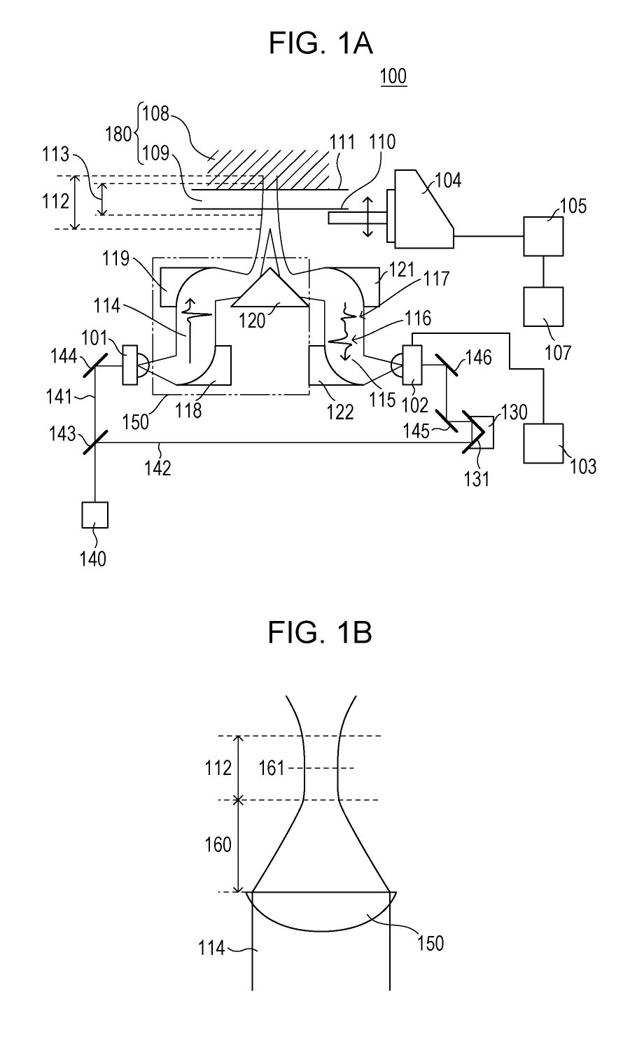

Referring now to FIGS. 1A and 1B, a measurement apparatus 100 (hereinafter, referred to as “apparatus 100”) of a first embodiment will be described. FIG. 1A is an explanatory drawing illustrating a configuration of the apparatus 100. The apparatus 100 is an apparatus configured to measure a time waveform of a terahertz wave by using a TDS method. The apparatus 100 includes a generating unit 101, a detecting unit 102, an analyzing unit 103, a position adjusting unit 104, a positional information acquiring unit 105 (hereinafter, referred to as “acquiring unit 105”), a relationship information output unit 107 (hereinafter, referred to as “output unit 107”), a time difference adjusting unit 130, a light source 140, and an irradiating unit 150.

The apparatus 100 includes a computer provided with a CPU, a memory, and a memory device or the like, and the computer has functions of the analyzing unit 103, the position adjusting unit 104, the acquiring unit 105, the output unit 107, and the time difference adjusting unit 130, or the like. The computer may be composed of a general-purpose computer, or may be composed of a dedicated hardware such as a board computer or an ASIC. Part of the functions that the computer has may be replaced by another computer or hardware such as a logic circuit.

The light source 140 generates a terahertz wave and outputs light used for detection (excitation light). The light output from the light source 140 is an ultrashort pulse laser. The light is split by a beam splitter 143 into a pump light 141 entering the generating unit 101 and a probe light 142 entering the detecting unit 102. The pump light 141 enters the generating unit 101 from the beam splitter 143 via a mirror 144. The probe light 142 enters the detecting unit 102 via an adjusting unit 130 and mirrors 145 and 146. Unlike this configuration, a configuration in which a light source configured to output the pump light and a light source configured to output the probe light are provided separately, and a configuration in which the pump light 141 passes the adjusting unit 130 are also applicable.

The generating unit 101 generates an input pulse 114, which is a pulsed terahertz wave, when the pump light 141 enters. The generated terahertz wave has a component in an arbitrary frequency band in a range from 0.03 THz to 30 THz. The input pulse 114 typically has a pulse width from several tens to several hundreds femtoseconds. A photoconductive device and generating element using non-linear optical crystal may be applied to the generating unit 101. This disclosure is not limited thereto, and the generating unit 101 needs only generate the input pulse 114 by an incidence of the pump light 141 and a known technology which can realize this purpose may be applied.

A first surface 110 and a second surface 111 of an object to be measured 180 having a sample 108 and a member 109 are irradiated with the generated input pulse 114 by the irradiating unit 150. Here, the member 109 is a plate-shaped member having two opposing flat surfaces and the sample 108 is arranged on one of the surfaces.

As regards the flatness of the two opposed surfaces of the member 109, an error of information on the sample 108 at a focused frequency or frequency band can fall within a range which satisfies specified accuracy, and the less depressions and projections and the more flatness the two surfaces have, the better. As regards the parallelism of the two opposed surfaces, an error of information on the sample 108 at the focused frequency or frequency area can fall within a range which satisfies specified accuracy, and the more parallel the two surfaces are, the better. The two opposed surfaces are required to be flat and parallel to each other more as the wavelength of the electromagnetic wave at the focused frequency or the frequency band decreases.

The irradiating unit 150 is configured to shape a beam propagation shape of the input pulse 114 and collect the input pulse 114 at an arbitrary converging position. The input pulse 114 is guided to the object to be measured 180 by the irradiating unit 150. The irradiating unit 150 includes a plurality of mirror 118, 119, and 120. Specifically, the beam shape of the input pulse 114 is shaped via the mirrors (118, 119, 120), and the first surface 110 and the second surface 111 of the object to be measured 180 are irradiated with the shaped input pulse 114.

With reference to FIG. 1B, a state in which the input pulse 114 is shaped in the case where a light-collecting lens is used as the irradiating unit 150 will be described. Since the wavelength of the terahertz wave is long, the input pulse 114 shaped in the irradiating unit 150 includes a depth of focus 112 on the order of several millimeters and a converging course area 160 until reaching the depth of focus 112 as illustrated in FIG. 1B. A converging position 161 is provided in the depth of focus 112, and the beam diameter of the input pulse 114 is minimized at the converging position 161. The depth of focus 112 is an area which can be recognized that the input pulse is propagated as the parallel light. Here, the term “depth of focus” is defined as a range in which the beam diameter of the input pulse 114 becomes w×√2 or smaller, where w is the minimum beam diameter (the beam diameter at the converging position 161) in the case where the beam diameter of the terahertz wave (input pulse) 114 is narrowed.

The first surface 110 and the second surface 111 are arranged at different position in a thickness direction of the member 109. In this embodiment, the first surface 110 is a front surface of the member 109, and the second surface 111 is a back surface of the member 109. The first surface 110 is a surface where the input pulse 114 enters first, and in this embodiment, is defined as a reference surface. The second surface 111 is an interface between the sample 108 and the member 109 and, in this embodiment is defined as a measurement surface. Here, the first surface 110 and the second surface 111 are adjacent to each other. However, there may be a different surface between the first surface 110 and the second surface 111.

When the first surface 110 and the second surface 111 are irradiated with the input pulse 114, terahertz waves (output pulse) 115 reflected from the respective surfaces are observed. In particular, in an output pulse 115, the terahertz wave of the irradiated input pulse 114 reflected from the first surface 110 is referred to as a first pulse 116, and that reflected from the second surface 111 is referred to as a second pulse 117.

The output pulse 115 is input to the detecting unit 102 via mirrors 120, 121 and 122. The detecting unit 102 is a portion which detects the output pulse 115. As the detecting unit 102, a method of detecting an electric field by using the above-described photoconductive device and an electro-optic effect, and a method of detecting a magnetic field by using a magneto-optic effect may be applied. The detecting unit 102 may detect the output pulse 115 by the probe light 142, and known technologies that can realize this purpose can be applied. The time point when the detecting unit 102 detects the output pulse 115 is adjusted by the time difference adjusting unit 130.

The time difference adjusting unit 130 adjusts the time difference between the probe light 142 and the output pulse 115 which reach the detecting unit 102. The time difference adjusting unit 130 of the first embodiment moves a mirror 131 configured to reflect and return the probe light 142 and changes an optical path length of the probe light 142. Accordingly, the optical path length difference between the optical path length of the pump light 141 from the beam splitter 143 to the generating unit 101 and the optical path length of the probe light 142 from the beam splitter 143 to the detecting unit 102 is changed and enables sampling measurement of the output pulse 115. The mode of the time difference adjusting unit 130 is not limited thereto, and may be of any type as long as the time point of detection by the detecting unit 102 can be adjusted. The time difference adjusting unit 130 is controlled by a control unit, which is not shown.

The position adjusting unit 104 relatively adjusts a position of the object to be measured 180 and the converging position 161 of the terahertz wave shaped in the irradiating unit 150 in the depth direction of the object to be measured 180 (hereinafter, may be referred to simply as “depth direction”). Specifically, the positions of the first surface 110 and the second surface 111 with respect to the converging position 161 of the terahertz wave shaped in the irradiating unit 150 are relatively adjusted. The position adjusting unit 104 is a stage configured to support the member 109, and moves the stage to move the member 109, so that the sample 108 is integrally moved. Accordingly, the first surface 110 and the second surface 111 are moved to relatively adjust the positions.

The positions may be relatively adjusted by moving the converging position 161 of the terahertz wave. More specifically, the generating unit 101, the detecting unit 102, and the mirrors (118, 119, 120, 121, and 122) configured to shape the terahertz wave are moved integrally to change the converging position 161. It is also possible to replace part of the mirrors with lenses and move the positions of the lenses to move the converging position 161. For example, the converging position 161 and the position of the object to be measured 180 in the depth direction are relatively adjusted by replacing the part of the mirrors with a system configured to converge the terahertz wave by the lens, irradiate the object to be measured 180 and collect the wave and adjusting the distance between the lens and the object to be measured 180.

In the case of using the member 109, which is the parallel flat plate as in the first embodiment, the “depth direction of the object to be measured” is a direction of the height extending from the front surface of the member 109 to the surface opposing the front surface (back surface), and is the same as the direction of the thickness of the member 109. The position adjusting unit 104 is not limited to the movable stage, and may be of any member as long as the position of the object to be measured 180 and the converging position 161 of the terahertz wave shaped in the irradiating unit 150 in the depth direction are able to be changed relatively.

The acquiring unit 105 acquires positional information on a measurement area 113 included in the depth of focus 112. The measurement area 113 is an area in which influence by a difference in the states of the terahertz waves such as changes in the intensities of a first pulse 116 and a second pulse 117 or the distance therebetween can be ignored or canceled. The measurement area 113 is within the depth of focus 112, and is an accuracy assured area which assures that the result of measurement measured in the measurement area 113 achieves accuracy specified by a measuring person.

The acquiring unit 105 acquires the positional information on the measurement area 113 by using relationship information output by the output unit 107. Detailed description regarding the acquisition of the positional information on the measurement area 113 will be described later. The positional information on the measurement area 113 includes information which indicates the range of the measurement area 113 with reference to a certain position, and information indicating the position of the center of the measurement area 113 in the depth direction. However, this disclosure is not limited thereto.

The output unit 107 outputs the relationship information to the acquiring unit 105 from a memory medium which memorizes the relationship information. The output unit 107 is a memory medium provided in the interior of the apparatus 100, an external memory medium, or a memory medium provided externally of the apparatus 100 which outputs the relationship information to the apparatus 100 via internet, and includes the relationship information obtained in advance.

The relationship information is a graph, a table and the like which indicates the relationship of the positions of the first surface 110 and the second surface 111 with respect to the intensities or the beam propagation shapes of the first pulse 116 and the second pulse 117. Specifically, information on a change of a peak value of the intensity of the time waveform of the output pulse 115 (hereinafter, referred to as “intensity peak value”) in the case where the positions of the first surface 110 and the second surface 111 are changed, or information regarding the change of the beam diameter of the output pulse 115 are exemplified.

The acquiring unit 105 acquires the positional information on the measurement area 113 from the output unit 107, and outputs the acquired positional information to the position adjusting unit 104. The position adjusting unit 104 moves the object to be measured 180 so that the first surface 110 and the second surface 111 are stored in the measurement area 113 on the basis of the positional information on the measurement area 113 that the acquiring unit 105 has acquired. When an adjustment of the position of the first surface 110 and the second surface 111 is completed, the apparatus 100 measures the time waveform of the output pulse 115.

The analyzing unit 103 acquires information on the second surface 111, which is a measurement surface, by using a time waveform of the first pulse 116 and a time waveform of the second pulse 117 included in the time waveform of the output pulse 115. Specifically, information on the sample 108 adjacent to the second surface 111 from the change of the time waveform of the second pulse 117 with respect to the time waveform of the first pulse 116 in the time waveform of the output pulse 115 is acquired. In other words, the first pulse 116 is used as the reference signal and the second pulse 117 is used as the measurement signal, and information on the sample 108 is acquired from the ratio of the both pulses.

The expression “information on the sample” in this specification here is defined as including at least one of a spectrum acquired from the time waveform and “physical properties” of the sample. The term “spectrum” in this specification corresponds to a spectral of the optical characteristics with a lateral axis indicating the frequency, and includes an amplitude spectrum and a phase spectrum of the terahertz wave acquired by applying Fourier transform on the time waveform. An intensity spectrum, a reflectance spectrum, a refractive index spectrum, a dielectric constant spectrum, a complex reflectivity spectrum, a complex refractive index spectrum, a complex dielectric constant spectrum, a complex conductivity spectrum, and the like are also included. The “physical properties” of the sample are defined to include a complex amplitude reflectivity, a complex refractive index, a complex dielectric constant, a reflectivity, a refractive index, an absorption coefficient, a dielectric constant, and an electric conductivity of the sample at a given one or a plurality of frequencies.

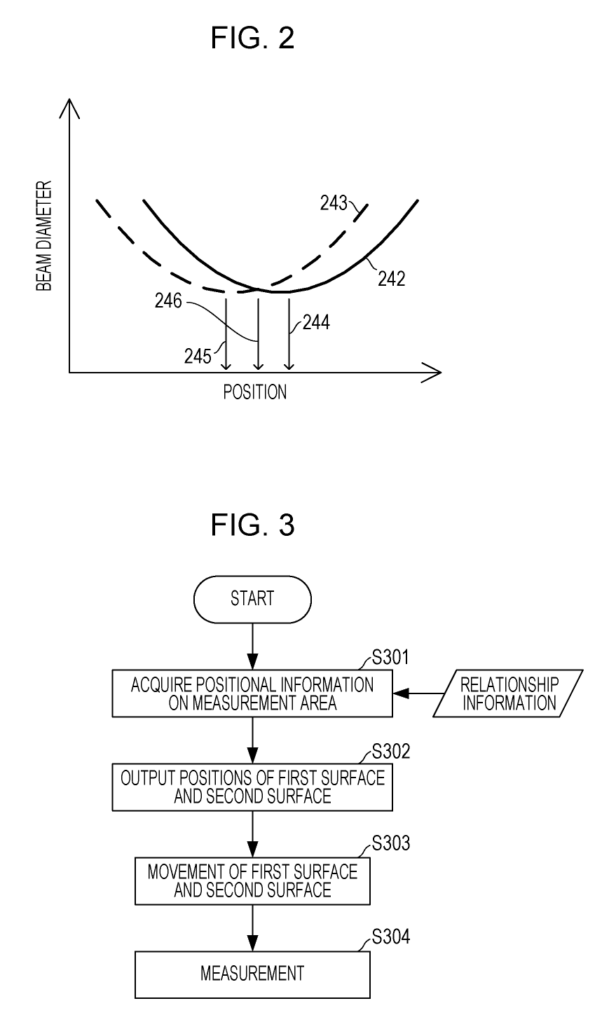

Referring now to FIG. 2, a method of acquiring of the positional information on the measurement area 113 will be described. FIG. 2 illustrates a relationship information of the first embodiment. Here, a relationship of the positions of the first surface 110 and the second surface 111 in the depth direction with respect to the beam diameter of the first pulse 116 and the beam diameter of the second pulse 117 is used as the relationship information. The lateral axis of FIG. 2 represents information on the positions of the first surface 110 and the second surface 111 in the depth direction and indicates a distance from an arbitrary position set to zero. The vertical axis represents the value of the beam diameter values of the first pulse 116 and the second pulse 117 in a plurality of different positions of the first surface 110 and the second surface 111 in the depth direction. The output unit 107 memorizes the information on the beam diameter as the relationship information.

In general, the beam diameters on the first surface 110 and the second surface 111 are difficult to be measured directly. Therefore, the beam diameters of the first pulse 116 and the second pulse 117 reflected from the first surface 110 and the second surface 111 are obtained respectively, and the obtained beam diameters are used as the beam diameters on the first surface 110 and the second surface 111.

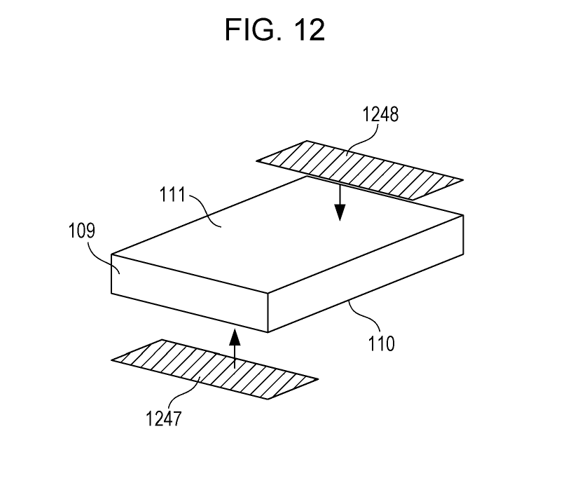

For example, this relationship information may be obtained as follows. As illustrated in FIG. 12, a first reflecting member 1247 and a second reflecting member 1248 which reflect the terahertz wave are provided on the front surface and the back surface of the member 109. Then, the intensities of the terahertz wave reflected from the first reflecting member 1247 and the terahertz wave reflected from the second reflecting member 1248 are detected respectively by the detecting unit 102. At this time, the terahertz wave is detected by the detecting unit 102 while changing an amount of blocking the terahertz wave (an output pulse 115) entering the detecting unit 102 by a knife edge method. Accordingly, the beam diameters of terahertz waves 116 and 117 reflected respectively from the first surface 110 and the second surface 111 may be obtained from a change of outputs. Relationship information can be acquired by plotting the beam diameter of the first pulse 116 and the beam diameter of the second pulse 117 at a plurality of different positions in the depth direction in the manner described above while changing the position of the member 109 by the position adjusting unit 104 along the depth direction.

The acquiring unit 105 acquires the positional information on the measurement area 113 with the acquired relationship information. Specifically, the acquiring unit 105 obtains a position (first position) 244 at which the beam diameter becomes the smallest in a locus 242 of the beam diameter of the first pulse 116, and obtains a position (second position) 245 at which the beam diameter becomes the smallest in the locus 243 of the beam diameter of the second pulse 117. The acquiring unit 105 obtains an intermediate position 246 between the first position 244 and the second position 245, and the intermediate position 246 is employed as the positional information on the measurement area 113.

The position adjusting unit 104 arranges a center of the member 109 at the intermediate position 246 on the basis of the acquired positional information on the measurement area 113. Accordingly, the position of arrangement of the first surface 110 and the second surface 111 are equal from the intermediate position 246. Therefore, influences of the difference in the states of the terahertz waves generated by the fact that the positions of the first surface 110 and the second surface 111 in the depth direction are different become almost the same. In other words, the position adjusting unit 104 can arrange the first surface 110 and the second surface 111 in the measurement area 113 in which the influences of the difference in the states can be ignored.

FIG. 3 is a flowchart of a measuring method of this embodiment. In the first embodiment, the relationship information acquired in advance by using the apparatus 100 and memorized in the output unit 107 is used. When the operation of the apparatus 100 is started, the acquiring unit 105 refers to the relationship information in the output unit 107 and acquires the positional information on the measurement area 113 (S301). In the first embodiment, as described above, the intermediate position 246 between the first position 244 and the second position 245 is acquired by using the relationship information, and the acquired relationship information is used as the positional information on the measurement area 113. The acquiring unit 105 outputs the positions where the first surface 110 and the second surface 111 are to be moved to the position adjusting unit 104 on the basis of the acquired positional information (S302). Here, the positions where the first surface 110 and the second surface 111 are positioned at the same distance from the intermediate position 246 are output from the acquiring unit 105.

The position adjusting unit 104 refers to the positions of the first surface 110 and the second surface 111 output from the acquiring unit 105, and moves the first surface 110 and the second surface 111 (S303). When the movement of the first surface 110 and the second surface 111 is completed, the apparatus 100 starts measuring the time waveform of the output pulse 115 (S304). The analyzing unit 103 acquires the information of the sample 108 by using a measured result.

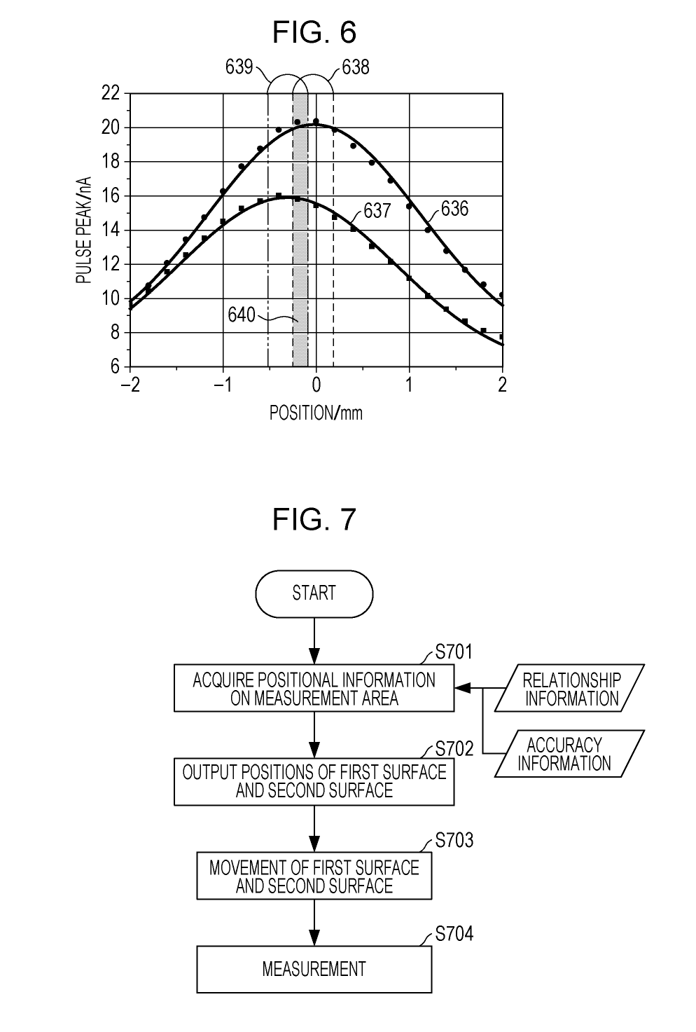

In the description given thus far, the example in which the information on the beam diameter is used as the relationship information has been described. However, information about the pulse intensity peak value as illustrated in FIG. 6 may also be used as the relationship information. In this case, an intermediate position between the position where the intensity of the first pulse 116 becomes the largest and the position where the intensity of the second pulse 117 becomes the largest may be acquired and used as the positional information on the measurement area 113.

In the measuring method of the first embodiment, the relationship information on the first pulse 116 from the first surface 110 and the second pulse 117 from the second surface 111 is referred to, the area where the influences of the difference in the states of the terahertz wave on the respective surfaces are approximately the same is determined as the measurement area 113, and the positional information on the measurement area 113 is acquired. Since the positions of the first surface 110 and the second surface 111 in the depth direction are adjusted so as to be arranged within the measurement area 113, the influence of the difference in states of the terahertz waves included in the time waveform of the terahertz wave may be reduced. In other words, the converging position 161 of the terahertz wave and the position of the object to be measured 180 in the depth direction are adjusted relatively, so that the influence of the difference in the states of the terahertz waves may be reduced.

Also, the relationship information is acquired in advance while relatively changing positions of the first surface 110 and the second surface 111 and the converging position 161 in the depth direction by the position adjusting unit 104, and positional information on the measurement area 113 is acquired by using the acquired relationship information. Therefore, the area where the first and second surfaces 110 and 111 are to be arranged may be determined by using the relationship information including the accuracy of the positioning of the position adjusting unit 104, and hence the first surface 110 and the second surface 111 may be arranged within the measurement area 113 more accurately than the case where the relationship information is not used.

### Second Embodiment

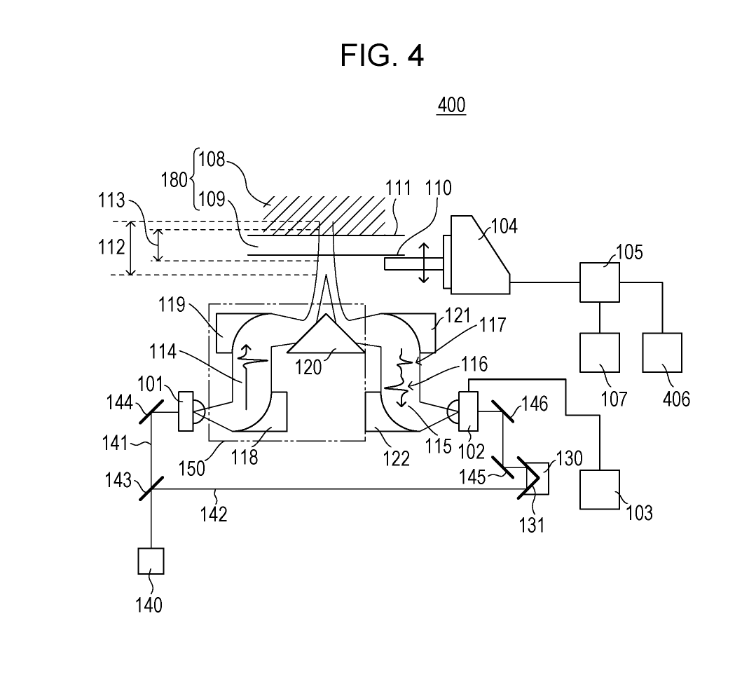

In a second embodiment, accuracy information is used in addition to the relationship information which has been described thus far in order to determine the measurement area 113. Referring now to FIG. 4, a measurement apparatus 400 (hereinafter, referred to as “apparatus 400”) of a second embodiment will be described. The apparatus 400 includes an accuracy information output unit 406 (hereinafter, referred to as “output unit 406”) in addition to the configuration of the apparatus 100 of the first embodiment. Description of parts common to the first embodiment described above will be omitted.

The output unit 406 is a portion configured to output the accuracy information, and is a memory medium provided inside or outside of the apparatus 400. An external memory medium or the like is also applicable. The acquiring unit 105 of the second embodiment is configured to acquire positional information of the measurement area 113 by using the accuracy information in the output unit 406 together with the relationship information in the output unit 107.

The output unit 406 uses an allowable value of a variation in intensity peak value generated between the first surface 110 and the second surface 111 depending on the positions where the first surface 110 and the second surface 111 are arranged as the accuracy information. The allowable value may be determined by directly selecting an allowable value by a person who measures. If the person who measures determines accuracy required for the measurement, a configuration in which the output unit 406 acquires the allowable value required for satisfying the accuracy is also applicable. In this case, the output unit 406 may acquire the allowable value by calculating an allowable value from the accuracy specified by the person who measures or by using a graph or a table which indicates the relationship between the accuracy and the allowable value acquired in advance. The accuracy information is not limited to the allowable value of variations, and may be specified accuracy itself.

Not only the variation in peak value, but also a measurement resolution of the physical properties which is desired to be evaluated finally may be used as the specified accuracy. For example, in the case where the refractive index is acquired as the physical properties, a difference in refractive index values which are desired to be read as the measurement resolution is used as the accuracy. In this case, the output unit 406 may acquires the allowable value by calculating an allowable value from the accuracy specified by the person who measures or by using a graph or a table which indicates the relationship between the accuracy and the allowable value acquired in advance.

Referring now to FIG. 6, acquisition of the positional information on the measurement area 113 will be described. FIG. 6 is a drawing illustrating the relationship information of the second embodiment, and indicates a relationship of the positions of the first surface 110 and the second surface 111 with respect to the intensities of the first pulse 116 and the second pulse 117. The lateral axis of the graph in FIG. 6 indicates information relating to the positions of the first surface 110 and the second surface 111 in the depth direction. Here, the lateral axis of the graph indicates a scale value of the position adjusting unit 104 for figuring out the position of the position adjusting unit 104. This indicates the distance of movement of the position adjusting unit 104 from an arbitrary position as a zero. The vertical axis is an intensity peak value of the first pulse 116 and the second pulse 117. In other words, FIG. 6 indicates a change in the intensity peak values of the first pulse 116 and the second pulse 117 due to a change in the positions of the first surface 110 and the second surface 111.

According to FIG. 6, an extreme value of a locus 636 of the intensity peak value of the first pulse 116 and an extreme value of a locus 637 of the intensity peak value of the second pulse 117 are at different positions. Here, the intensities of the first pulse 116 and the second pulse 117 become the largest at respective extreme values of the loci 636 and 637. It is because a distance d between the first surface 110 and the second surface 111 is a fixed value, and the lateral axis indicates the position of the first surface 110. In other words, the position of the second surface 111 follows the movement of the position of the first surface 110 and changes, and the position of the second surface 111 can be obtained by adding the distance d to the position of the first surface 110 as a reference indirectly.

From this reason, a difference between a position of the extreme value of the locus 636 and a position of the extreme value of the locus 637 is an effective distance converted from the distance d between the first surface 110 and the second surface 111. The term “effective distance” here means a distance that the electromagnetic wave detects, and changes by the physical properties of an object interposed between the first surface 110 and the second surface 111. From these reasons, if the distance d changes, the position of the extreme value also changes.

In the second embodiment, the distance d between the first surface 110 and the second surface 111 is determined by the thickness of the member 109. In the case where the position adjusting unit 104 has a configuration to adjust the position of the member 109, the first surface 110 and the second surface 111 move in association with the movement of the member 109. In other words, the lateral axis of FIG. 6 may be considered to be the positional information that the position adjusting unit 104 has. Specifically, the lateral axis indicates plotted values of an intensity peak value 636 of the first pulse and an intensity peak value 637 of the second pulse when the member 109 is located at a certain position.

The member 109 is formed of a Z-cut quartz having a thickness (distance d) of 0.5 mm. The front surface and the back surface of the member 109 are determined as the first surface 110 and the second surface 111, respectively, the detecting unit 102 detects the intensity of the first pulse and the intensity of the second pulse respectively, and the loci 636 and 637 of the peak values of the respective intensities are indicated in the information. The detecting unit 102 detects signals of the first pulse 116 and the second pulse 117 as current values. At this time, a difference between the position of the extreme value of the locus 636 of the intensity peak value of the first pulse, and the position of the extreme value of the locus 637 of the intensity peak value of the second pulse is approximately 0.36 mm, and if the refractive index of the quartz (approximately 1.4) is used, the difference becomes 0.5 mm. This matches the thickness of the used member 109.

A method of determining the measurement area 113 will be descried. The measurement area 113 is determined by using the accuracy information on the measurement accuracy specified in addition to the relationship information, for example. According to the study of the inventors, for example, in the case of obtaining the refractive indexes of the sample 108 at accuracy of 0.01, the difference between the intensity peak value of the first pulse 116 and the intensity peak value of the second pulse 117 needs to fall within 1%. In other words, variations in the intensity peak value generated between the first surface 110 and the second surface 111 depending on the positions where the first surface 110 and the second surface 111 are arranged needs to be limited within 1%. In this example, the allowable value of the variation is used as the accuracy information.

Here, a first area 638 which satisfies a desired accuracy with respect to the intensity peak value of the first pulse is such that the position of the first surface 110 is an area between −0.272 mm to 0.212 mm because the variation in the extreme value of the locus falls within the range within 1%. In the same manner, a second area 639 which satisfies a desired accuracy with respect to the intensity peak value of the second pulse falls within a range from −0.575 mm to −0.090 mm.

An overlapped area 640 in which the first area 638 and the second area 639 overlap falls within a range from −0.272 mm to −0.090 mm. Here, the lateral axis of FIG. 6 is a scale value of the position adjusting unit 104. In other words, if the range of the movement of the position adjusting unit 104 falls within the range from −0.272 mm to −0.090 mm from the reference position, the variation in intensity peak value may be limited within 1%. Therefore, when the position adjusting unit 104 moves within the range, the area in which the first surface 110 and the second surface 111 are arranged is determined as the measurement area 113.

In other words, the size of the measurement area 113 is 0.622 mm, which is a value of a sum of the distance d between the first surface 110 and the second surface 111 and the range of the overlapped area 640. The acquiring unit 105 outputs an arbitrary value of the overlapped area 640 (a range from −0.272 mm to −0.090 mm) as the positional information on the measurement area 113. The position adjusting unit 104 refers to the output of the acquiring unit 105, adjusts the position of the member 109, and arranges the first surface 110 and the second surface 111 indirectly within the measurement area 113.

When the measurement area 113 is determined, the apparatus 400 of the second embodiment acquires the positional information on the measurement area 113 by using the accuracy information on the required measurement accuracy. The boundary of the measurement area 113 is determined. Therefore, assurance of the accuracy of the measurement apparatus is easily achieved. The apparatus 400 determines the measurement area 113 dynamically by using the information on the locus (636 and 637) of the peak values of the first pulse 116 and the second pulse 117, and the accuracy information. Therefore, the measurement apparatus is capable of accommodating the change of the measurement accuracy easily.

FIG. 7 is a flowchart of the measurement method of the second embodiment. When the operation of the apparatus 100 is started, the acquiring unit 105 uses the relationship information in the output unit 107 and the accuracy information in the output unit 406 to acquire the positional information on the measurement area 113 (S701).

Subsequently, the acquiring unit 105 outputs the positions where the first surface 110 and the second surface 111 are to be arranged to the position adjusting unit 104 on the basis of the acquired positional information on the measurement area 113 (S702). The position adjusting unit 104 refers to the positions of the first surface 110 and the second surface 111 output from the acquiring unit 105, and moves the first surface 110 and the second surface 111 (S703). When the movement of the first surface 110 and the second surface 111 is completed, the apparatus 100 measures the time waveform of the output pulse 115 (S704).

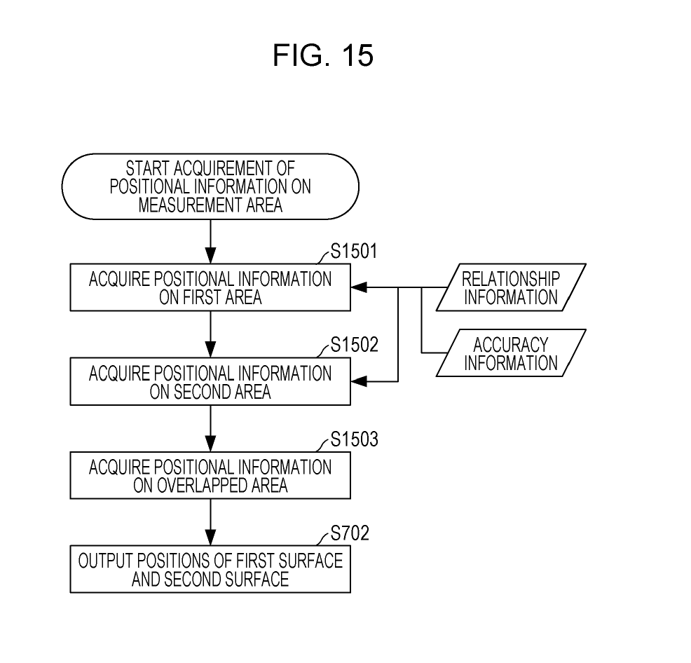

FIG. 15 is a flowchart describing a detailed operation flow of Step S701 in which the acquiring unit 105 acquires the positional information on the measurement area 113.

A step that the acquiring unit 105 acquires the information of the measurement area 113 (S701) includes a next step. The acquiring unit 105 acquires the relationship information and the accuracy information, and acquires the positional information on the first area 638 which satisfies the desired measurement accuracy by using the relationship information and the accuracy information (S1501). Subsequently, the acquiring unit 105 refers to the relationship information and the accuracy information, and acquires the positional information on the second area 639 which satisfies the desired measurement accuracy (S1502). The acquiring unit 105 acquires the positional information on the overlapped area 640 in which the first area 638 and the second area 639 overlap each other (S1503). Subsequently, the procedure goes to the above-described step S702, and the acquiring unit 105 outputs the positions where the first surface 110 and the second surface 111 are arranged which are accommodated within the measurement area 113 on the basis of the positional information on the overlapped area 640, which is the measurement area 113.

The measuring method determines a range of the measurement area 113 by using the accuracy information on the required measurement accuracy when determining the measurement area 113. The position of the object to be measured 180 is adjusted on the basis of the positional information on the acquired measurement area 113, so that the converging position 161 of the terahertz wave and the position of the object to be measured 180 are relatively adjusted in the depth direction, whereby the influence of the difference in the states of the terahertz wave included in the time waveform of the terahertz wave may be reduced.

There is a case where the measurement area 113 for satisfying the desired measurement accuracy is very small or the measurement area 113 does not exist and hence the first surface 110 and the second surface 111 cannot be arranged within the measurement area 113. In such a case as well, by acquiring the positional information on the measurement area 113 by using the relationship information and the accuracy information as in the second embodiment, the fact that the measurement cannot be achieved within the measurement area 113 is known in advance, so that the user is avoided from doing unnecessary measurement or measurement with low degree of accuracy. In addition, the relationship information is acquired while changing the position in the depth direction among the first surface 110 and the second surface 111 by the position adjusting unit 104, and positional information on the measurement area 113 is acquired by using the acquired relationship information. Therefore, the relationship information including the accuracy of the positioning of the position adjusting unit 104 can be used, and hence the first surface 110 and the second surface 111 may be arranged within the measurement area 113 more accurately than the case where the relationship information is not used.

In the first embodiment, an area in which the influence of the difference in the states of the terahertz wave are almost the same is selected as the measurement area 113. In addition, however, in the second embodiment, the range of the measurement area 113 is determined by adding conditions that the measurement accuracy required by the person who measures are satisfied. Therefore, the area that measurement with required accuracy is possible is acquired as the measurement area 113, and the measurement accuracy is assured. In addition, since the measurement area 113 is dynamically determined by using the relationship information and the accuracy information, even though the measurement accuracy required by the person who measures changes, the configuration in the second embodiment is capable of responding easily to such a condition.

### Third Embodiment

A measurement apparatus 900 (hereinafter, referred to as “apparatus 900”) of a third embodiment will be described. The third embodiment is different from the embodiments described thus far in that the distance between the first surface 110 and the second surface 111 is determined while referring to the accuracy information. Description of portion common to the description given above will be omitted.

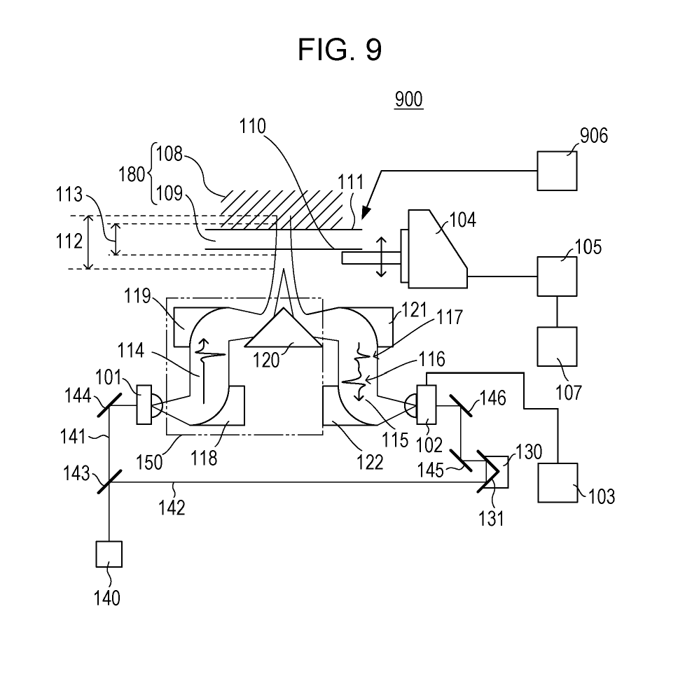

A configuration of the apparatus 900 will be described with reference to FIG. 9. FIG. 9 is a configuration drawing of the apparatus 900. The apparatus 900 includes an accuracy information output unit 906 (hereinafter, referred to as “output unit 906”). The output unit 906 determines the distance d between the first surface 110 and the second surface 111 by using the accuracy information. More specifically, the thickness of the member 109 in accordance with the required measurement accuracy is obtained and the obtained thickness is determined as the distance d.

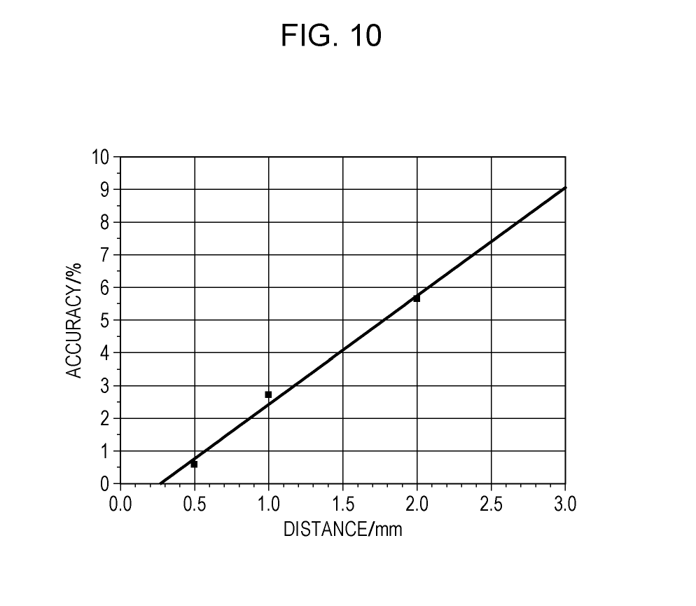

FIG. 10 is a drawing illustrating the relationship of the distance d between the first surface 110 and the second surface 111 with respect to the measurement accuracy. The output unit 906 has a relationship drawing as the accuracy information, and determines the distance d with this relationship drawing. The lateral axis in FIG. 10 represents the distance d between the first surface 110 and the second surface 111, and the vertical axis represents magnitudes (accuracy) of variations in intensity peak values of the first pulse 116 and the second pulse 117 with the distance d.

From FIG. 10, it is understood that the larger the distance d, the larger the magnitude of the variation substantially linearly. If the variations in intensity peak values of the first pulse 116 and the second pulse 117 increase, the measurement accuracy of the time waveform is lowered. Therefore, for example, the accuracy is lowered even though the refractive index is obtained as the information on the sample 108.

The output unit 906 obtains the distance in accordance with the accuracy required by the apparatus 900 by using the accuracy information as illustrated in FIG. 10 before acquiring the measurement area 113. By selecting the member 109 having a thickness smaller than the obtained distance, the distance between the first surface 110 and the second surface 111 may be adjusted indirectly. For example, in the case where the accuracy for satisfying the required measurement accuracy is 1% or smaller, the member 109 may have a thickness d of 0.6 mm or smaller. However, if the time waveforms of the first and second pulses 116 and 117 need to be cut out from the time waveform of the output pulse 115 in order to acquire the information on the sample 108, the member 109 can be selected so as to have a thickness which allows to be cut out.

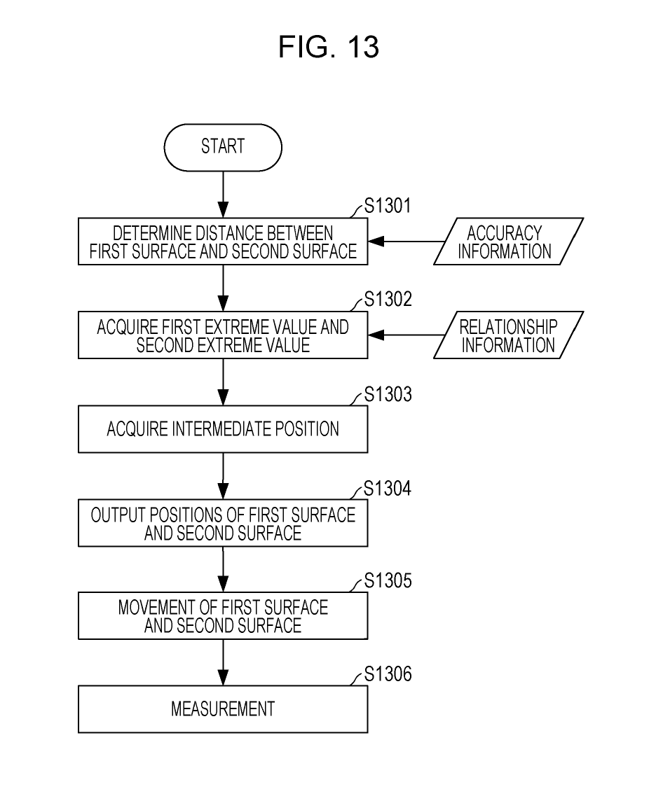

FIG. 13 is a flowchart of the measuring method of third embodiment. Here, a method of measuring by combining the measuring method of the first embodiment will be described. Information on the beam diameter of the input pulse 114 is used as the relationship information.

The measuring method of the third embodiment includes referring to the accuracy information in the output unit 906 and determining the distance d between the first surface 110 and the second surface 111 (S1301). Then, the acquiring unit 105 acquires a first extreme value 244 regarding the first pulse 116 and a second extreme value 245 regarding the second pulse 117 by the relationship information in the output unit 107 (S1302). Then, the intermediate position 246 between the first extreme value 244 and the second extreme value 245 is obtained as the positional information on the measurement area 113 (S1303).

Subsequently, the acquiring unit 105 outputs the positions of the first surface 110 and the second surface 111 on the basis of the acquired positional information on the measurement area 113 obtained in Step S1103 (S1304). Here, The acquiring unit 105 outputs the positions where the first surface 110 and the second surface 111 are positioned at the same distance from the center position of the measurement area 113 (the intermediate position 246). In the case where the lateral axis of the relationship information is at the position of the member 109, if the intermediate position 246 is output, the first surface 110 and the second surface 111 are arranged at the positions at the same distance from the center position of the measurement area 113 as a result.

The position adjusting unit 104 refers to the output from the acquiring unit 105, moves the object to be measured 180, and adjusts the positions of the first surface 110 and the second surface 111 (S1305). Subsequently, the apparatus 900 performs measurement of the time waveform of the output pulse 115 (S1306). A simple configuration in which the acquiring unit 105 outputs the positional information on the intermediate position 246 as the relationship information, and on the basis of the output, and the position adjusting unit 104 moves the center between the first surface 110 and the second surface 111 to the intermediate position 246 is also applicable.

In the third embodiment, the converging position 161 of the terahertz wave and the position of the object to be measured 180 are relatively adjusted in the depth direction on the basis of the positional information on the acquired measurement area 113, whereby the influence of the difference in the states of the terahertz wave included in the time waveform of the terahertz wave may be reduced.

As needed, the distance between the first surface 110 and the second surface 111 is determined in advance in accordance with the required measurement accuracy. Therefore, arrangement of the first surface 110 and the second surface 111 at positions where the measurement accuracy cannot be assured is prevented, so that the operation of the apparatus 900 is stabilized. In addition, the relationship information is acquired in advance while changing the position among the first surface 110 and the second surface 111 by the position adjusting unit 104 in the depth direction, and positional information on the measurement area 113 is acquired by using the acquired relationship information. Therefore, the relationship information including the accuracy of the positioning of the position adjusting unit 104 can be used, and hence the first surface 110 and the second surface 111 may be arranged within the measurement area 113 more accurately than the case where the relationship information is not used.

### Fourth Embodiment

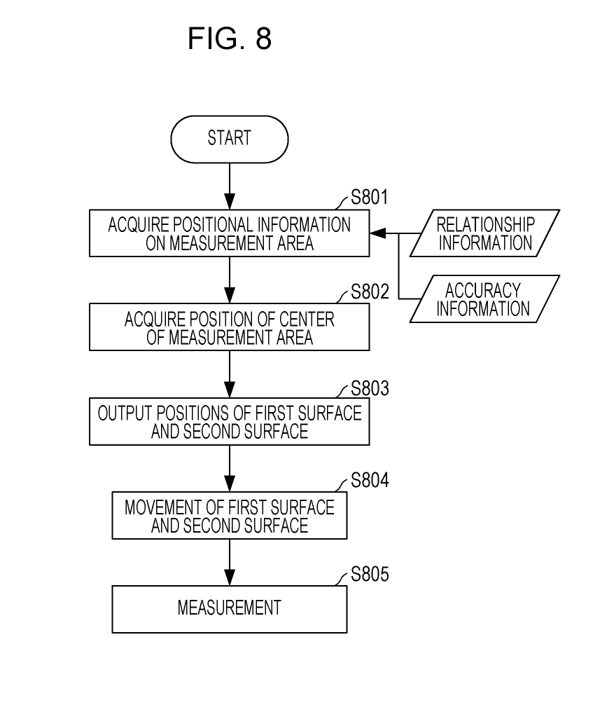

In a fourth embodiment, a modification relating to a method of determining the positions of the first surface 110 and the second surface 111 that the acquiring unit 105 outputs will be described with reference to FIG. 8. The measurement apparatus of the fourth embodiment has the same configuration as the apparatus 400 of the second embodiment. Description of portion common to the description given above will be omitted.

FIG. 8 is a flowchart of the measuring method of the fourth embodiment. In the fourth embodiment, information indicating a relationship between the positions of the first surface 110 and the second surface 111 in the depth direction and the intensity peak value of the pulse as illustrated in FIG. 6 is used as the relationship information.

First of all, as described in conjunction with the second embodiment, the acquiring unit 105 acquires positional information on the measurement area 113 by using the relationship information and the accuracy information as illustrated in FIG. 6 (S801). Accordingly, whether there is an area which can satisfy desired measurement accuracy is confirmed. The acquiring unit 105 acquires the extreme value of the locus 636 of the intensity peak value of the first pulse 116 and the extreme value of the locus 637 of the intensity peak value of the second pulse 117 from the relationship information in the output unit 107. Then, an intermediate position of the extreme values of the respective pulses is obtained, and is determined as a center position of the measurement area 113 (S802).

The acquiring unit 105 outputs the positions where the first surface 110 and the second surface 111 are positioned at the same distance from the center position of the measurement area 113 (S803). The position adjusting unit 104 refers to an output of the acquiring unit 105, and moves the first surface 110 and the second surface 111 (S804). In FIG. 6, in the case where the lateral axis of the relationship information is at the position of the member 109, if the intermediate position of the extreme values of the respective pulses is output, the first surface 110 and the second surface 111 are arranged at the positions at the same distance from the center position of the measurement area 113 as a result. When the movement is completed, the apparatus 400 performs measurement of the time waveform of the output pulse 115 (S805).

In the fourth embodiment, the converging position 161 of the terahertz wave and the position of the object to be measured 180 are relatively adjusted in the depth direction on the basis of the positional information on the acquired measurement area 113, whereby the influence of the difference in the states of the terahertz wave included in the time waveform of the terahertz wave may be reduced.

In the measuring method of the fourth embodiment, the first surface 110 and the second surface 111 are arranged at positions at the same distance from the center position of the measurement area 113. Therefore, when the measurement area 113 is determined, the first surface 110 and the second surface 111 are uniquely determined, so that the time required until the first surface 110 and the second surface 111 are arranged may be reduced. In addition, the relationship information is acquired in advance while changing the position among the first surface 110 and the second surface 111 by the position adjusting unit 104 in the depth direction, and positional information on the measurement area 113 is acquired by using the acquired relationship information. Therefore, the relationship information including the accuracy of the positioning of the position adjusting unit 104 can be used, and hence the first surface 110 and the second surface 111 may be arranged within the measurement area 113 more accurately than the case where the relationship information is not used.

### Fifth Embodiment

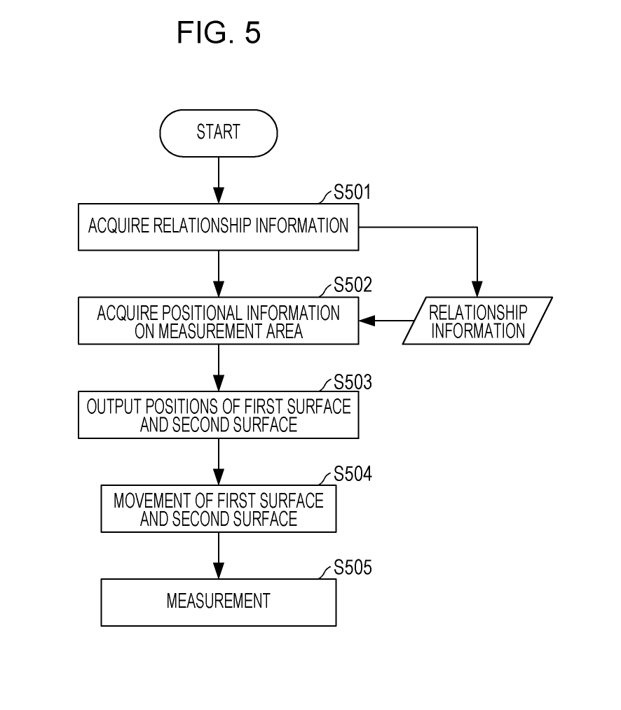

A fifth embodiment will be described with reference to FIG. 5. In the fifth embodiment, a modification of the measuring method will be described. Description of portion common to the description given above will be omitted.

FIG. 5 is a flowchart of the measuring method of the fifth embodiment. In the measuring method described thus far, information acquired in advance and stored in the output unit 107 is used as the relationship information. The fifth embodiment is different from the embodiments described thus far in that a measurement apparatus acquiring step for acquiring the relationship information with the measurement apparatus. The measurement apparatus used in the fifth embodiment is the apparatus 400 of the second embodiment.

In Step S501, the apparatus 400 performs the relationship information acquiring step for measuring the relationship information and recording the measured result in the output unit 107. Specifically, in the case where a change of the intensity peak value of the output pulse is used as the relationship information, the first pulse 116 and the second pulse 117 are detected respectively by the detecting unit 102 while changing the position of the member 109 or the object to be measured 180 in the depth direction by using the position adjusting unit 104. Then, the intensity peak values of the first pulse 116 and the second pulse 117 respectively in a plurality of different positions in the depth direction are recorded. In the case of using the beam diameter of the pulse, the beam diameters of the input pulse 114 at the respective positions are recorded by using the member 109 as described in FIG. 12 while changing the position of the member 109 in the depth direction. Accordingly, the relationship information is prepared.

In Step S502, the positional information on the measurement area 113 is acquired by using relationship information acquired in Step S501. Various methods described in another embodiment may be used as a method of acquiring the positional information on the measurement area 113. Subsequently, in the same manner as the above-described embodiment, the acquiring unit 105 outputs the positions of the first surface 110 and the second surface 111 on the basis of the positional information on the measurement area 113 (S503), and the position adjusting unit 104 adjusts the positions of the first surface 110 and the second surface 111 accordingly (S504). Subsequently, the apparatus 400 measures the time waveform of the output pulse 115 (S505).

In the fifth embodiment, the converging position 161 of the terahertz wave and the position of the object to be measured 180 are relatively adjusted in the depth direction on the basis of the positional information on the acquired measurement area 113, whereby the influence of the difference in the states of the terahertz wave included in the time waveform of the terahertz wave may be reduced.

Since the measuring method of the fifth embodiment dynamically acquires the relationship information, a change in the measurement condition of the measurement apparatus is easily accommodated. In other words, in order to acquire the relationship information before starting the measurement of the time waveform, the relationship information acquired in the state close to the actual measurement of the time waveform may be used. Therefore, the measurement area 113 can be determined including the influence of the state of the measurement apparatus or the change such as the measuring environment or the like, the measurement of the time waveform may be achieved with high degree of accuracy. In addition, the relationship information is acquired in advance while changing the position among the first surface 110 and the second surface 111 by the position adjusting unit 104 in the depth direction, and positional information on the measurement area 113 is acquired by using the acquired relationship information. Therefore, the relationship information including the accuracy of the positioning of the position adjusting unit 104 can be used, and hence the first surface 110 and the second surface 111 may be arranged within the measurement area 113 more accurately than the case where the relationship information is not used.

### Sixth Embodiment

In a sixth embodiment, first to fourth modifications of the member 109 of the above-described embodiments will be described. Description of portion common to the description given above will be omitted. Here, in the description, defining a surface where the terahertz wave reaches first as the front surface, and a surface opposing thereto as the back surface, the front surface of the member 109 is the first surface 110, and the back surface of the member 109 is the second surface 111. However, the inventions are not limited thereto, the second surface may be an interface of the interior of the sample 108.

Members 1101 to 1104 as the first to the fourth modification of the member 109 are members capable of adjusting the distance between the first surface 110 and the second surface 111. The members 1101 to 1104 respectively have a distance adjusting member 1134. The distance adjusting member 1134 is a portion for controlling the distance between the front surface and the back surface of the respective members 1101 to 1104, and the configurations are different depending on the configuration of the members. The configuration of the respective members 1101 to 1104 will be described in detail.

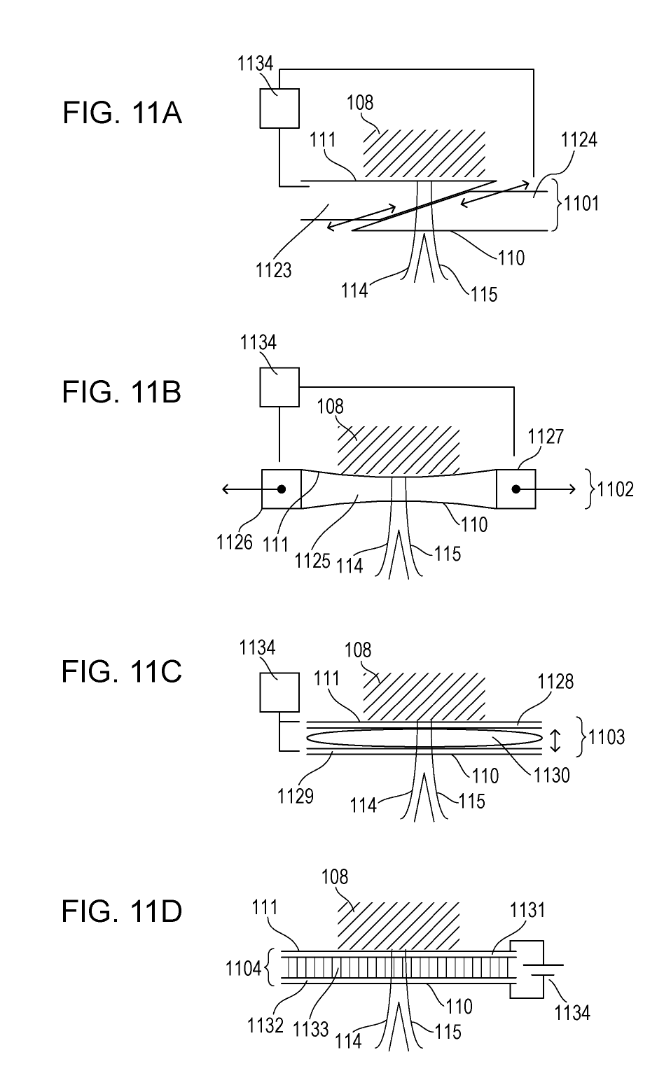

The member 1101 illustrated in FIG. 11A includes a first member 1123 and a second member 1124 cut obliquely at an end surface. The first member 1123 forms the back surface of the member 1101, and the second member 1124 forms the front surface of the member 1101.

The obliquely cut surfaces of the first member 1123 and the second member 1124 are opposed in contact to each other, and the first member 1123 and the second member 1124 are movable along a boundary of a bonding surface. An adjusting portion 1134 is an actuator and a controller for moving the first member 1123 and the second member 1124, and adjusts the distance between the first surface 110 and the second surface 111 by the distance adjusting member 1134.

The member 1102 as illustrated in FIG. 11B may be used. The member 1102 is formed by using a deformable member 1125. The deformable member 1125 is a member configured to be deformed by being applied with energy from the outside. For example, a resin which is easily expandable and contractible as rubber, or a resin applied temporarily with elasticity by being applied with heat or the like is also applicable. A first fixed portion 1126 and a second fixed portion 1127 are members for fixing deformation of the deformable member 1125. If the front surface and the back surface of the deformable member 1125 are defined as the first surface 110 and the second surface 111, respectively, the deformable member 1125 is deformed in an in-plane direction by adjusting the distance between the first fixed portion 1126 and the second fixed portion 1127 by the distance adjusting member 1134. Consequently, the distance between the first surface 110 and the second surface 111 can be adjusted.

The member 1103 illustrated in FIG. 11C interposes a deformable member 1130 between a first member 1128 and a second member 1129. The first member 1128 forms the second surface, and the second member 1129 forms the first surface 110. The first member 1128 and the second member 1129 are preferably formed of a material having a permeability for the terahertz wave such as a high-resistance silicon or an olefin-based resin.

The deformable member 1130 may be formed of one of the above-descried resins described as the material of the first member 1128 and the second member 1129, or a portion between the first member 1128 and the second member 1129 is filled with oil superior in permeability for the terahertz wave. The distance between the first member 1128 and the second member 1129 is changed by the distance adjusting member 1134, and the deformable member 1130 is changed in the thickness direction, so that the distance between the first surface 110 and the second surface 111 may be adjusted.

The member 1104 illustrated in FIG. 11D interposes an adjusting member 1133 between a first member 1131 and a second member 1132. The adjusting member 1133 is a member which can change the refractive index and, for example, a liquid crystal material having a refractive index changing by orientation may be used. The first member 1131 and the second member 1132 are provided with electrodes for changing the refractive indexes. Therefore, the distance adjusting member 1134 of the sixth embodiment is a portion which outputs a control signal for changing the refractive index. The first member 1131 forms the second surface 111, and the second member 1132 forms the first surface 111.

When the distance adjusting member 1134 outputs a control signal, the first member 1131 and the second member 1132 apply a voltage to an adjusting member 1133. Accordingly, the refractive index of the adjusting member 1133 changes. When the refractive index of the area where an electromagnetic wave propagates changes, a propagation speed of the electromagnetic wave changes. Therefore, if the refractive index between the first member 1131 and the second member 1132 changes, an effective distance between the first surface 110 and the second surface 111 is adjusted.

In the third embodiment, a distance between the first surface 110 and the second surface 111 adequate to satisfy a desired measurement accuracy by using the accuracy information, and a member having a thickness which fills the distance is selected. By using the members 1101 to 1104 described in the sixth embodiment, the thickness can be adjusted easily. In the case where the time waveform of the output pulse 115 is actually measured and then a change of the thickness of the member is desired for further improving the measurement accuracy, the thickness can be adjusted easily. The configuration of changing the distance between the first surface 110 and the second surface 111 is not limited thereto.

### Seventh Embodiment

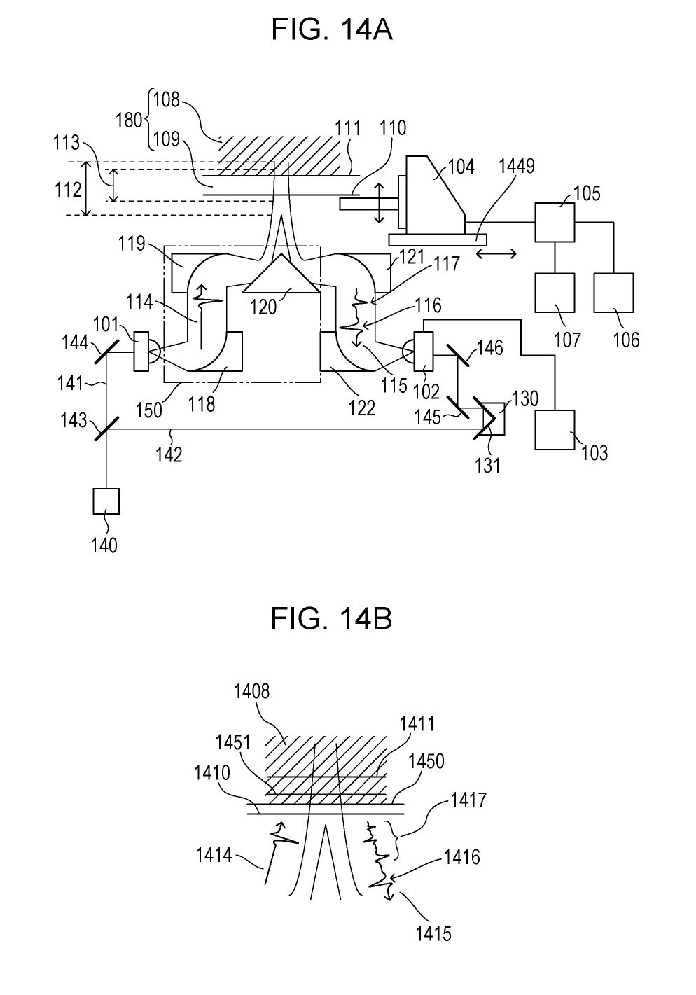

Referring now to FIG. 14A, a measurement apparatus 1400 (hereinafter, referred to as “apparatus 1400”) of a seventh embodiment will be described. The apparatus 1400 is an imaging apparatus configured to visualize a distribution of information on an acquired sample. Description of portion common to the description given above will be omitted.

FIG. 14A illustrates a configuration of an apparatus 1400 of the seventh embodiment. A portion different from the apparatuses of the above-described embodiments have a position changing unit 1449 for changing an irradiation position of the input pulse 114 with respect to the object to be measured 180. More specifically, the irradiating position of the input pulse 114 is moved with respect to the in-plane directions of the first surface 110 and the second surface 111.

In the seventh embodiment, the position changing unit 1449 is connected to the position adjusting unit 104, and the member 109 and the object to be measured 180 including the sample 108 is moved. However, the position changing unit 1449 may have a mode that scans the input pulse 114. For example, the input pulse 114 can be scanned by moving the generating unit 101, the detecting unit 102, and the mirrors (118 to 122) integrally. In this configuration, the apparatus 1400 may visualize the distribution of the physical properties of the second surface 111.

The second surface 111 does not necessarily have to be in an interface between the member 109 and the sample 108. For example, as illustrated in FIG. 14B, refractive index interfaces 1411 and 1451 in the interior of a sample 1408 may be defined as the second surface. Here, the interface 1411 needs to be the second surface. At this time, a plurality of interfaces may exist between the first surface 1410 and the second surface 1411. In other words, when the first surface 1410 is composed of the member 109 for forming a reference surface, an interface (third surface) 1450 between the member 109 and the sample 1408 and a refractive index interface (fourth surface) 1451 in the interior of the sample 1408 exist.

When the sample 1408 as described above is irradiated with an input pulse 1414, an output pulse 1415 in which pulses reflected from the respective surfaces exist together is obtained. For example, the output pulse 1415 is analyzed to determine a first pulse 1416 reflected from the first surface 1410 as a reference signal, and a pulse train 1417 reflected respectively from the second surface 1411, the third surface 1450, and the fourth surface 1451 as a measurement signal. Consequently, the internal structure of the sample 1408 is visualized.

When an input pulse 1414 is scanned one-dimensionally in an in-plane direction of the first surface 1410, a tomogram is acquired. When the input pulse 1414 is scanned in a two-dimensional direction, a three-dimensional structure in which the physical properties of the sample 1408 are reflected is acquired.

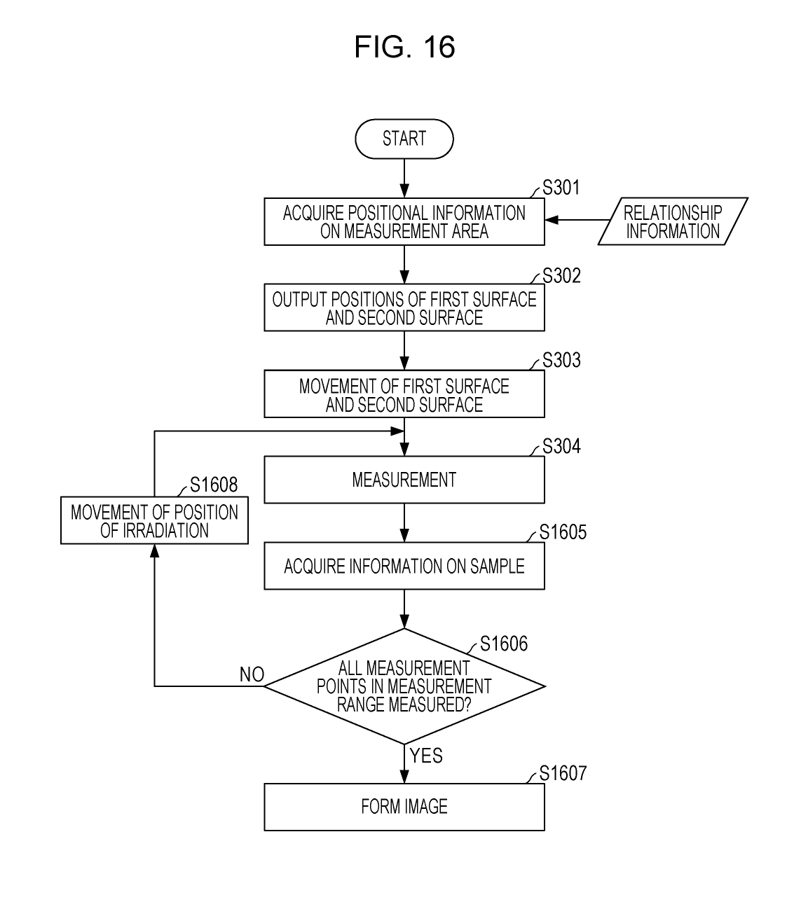

FIG. 16 is a flowchart of an image acquiring method for acquiring an image of the sample 108 by using the apparatus 1400. The acquiring unit 105 acquires positional information on the measurement area 113 (S301), and outputs the positions of the first surface 110 as the reference surface and the second surface 111 as the surfaces to be measured in the depth direction in a manner described in the above-described embodiments (S302). The position adjusting unit 104 moves along the object to be measured 180 on the basis of the positional information on the measurement area 113 acquired by the acquiring unit 105, and adjusts the positions of the first surface 110 and the second surface 111 in the depth direction (S303). Subsequently, the detecting unit 102 detects the output pulse 115, and measures the time waveform of the output pulse 115 (S304).

Subsequently, in Step S1605, the analyzing unit 103 acquires information on the sample 108 by using the acquired time waveform. Subsequently, whether the measurement of all of the points to be measured in the measurement range in which the control unit which is not illustrated acquires the image has terminated is confirmed (S1606), if the measurement is terminated, the procedure goes to Step S1607, and the image of the sample 108 is formed. In the case where the measurement of all of the points to be measured is not terminated, the procedure goes to Step S1608, and the irradiating position is moved by the position changing unit 1449 moving the object to be measured 180 in the in-plane direction so that another point to be measured within the measurement range is irradiated with the input pulse 114. Subsequently, the procedure goes back to Step S304, and the respective steps are performed until the measurement of all of the points to be measured is terminated.

In the seventh embodiment, the movement of the irradiating position is performed after the measuring Step S304. However, it may be performed before Step S301 in which the information of the measurement area 113 is acquired. Alternatively, the positional information on the measurement area 113 may be acquired again by returning the procedure back to Step S301 after the irradiating position is moved in Step S1608.

The apparatus 1400 acquires the positional information on the measurement area 113, and relatively adjusts the terahertz wave converging position 161 and the position of the object to be measured 180 in the depth direction on the basis of the acquired positional information on the measurement area 113. Accordingly, an influence of the difference in the states of the terahertz waves included in the time waveform of the terahertz wave may be reduced. Consequently, since the measurement accuracy for the time waveform of the terahertz wave is improved in comparison with those in the related art, the information of the sample can be acquired with higher accuracy, so that an image in which lowering of accuracy in acquisition of the physical properties of the sample by the terahertz wave is suppressed is acquired.

In the case where the position changing unit 1449 moves in the in-plane direction on the object to be measured 180 for imaging, there is a case where a positional displacement although it is minute may occur in a direction different from the in-plane direction (for example, the depth direction) in the case of the movement. However, if the range of the positional displacement is acquired in advance, the positions where the first and second surfaces 110 and 111 are to be arranged may be determined so as to be accommodated within the measurement area 113 even though the positional displacement occurs by using the positional information on the acquired measurement area 113 and the range of the positional displacement. Therefore, a probability that the first and second surfaces 110 and 111 are positioned out of the measurement area 113 due to the positional displacement in a direction different from the in-plane direction and the measurement accuracy is lowered may be reduced.

While the present inventions have been described with reference to exemplary embodiments, it is to be understood that the inventions are not limited to the disclosed exemplary embodiments. The scope of the following claims is to be accorded the broadest interpretation so as to encompass all such modifications and equivalent structures and functions.

For example, the acquiring unit 105 outputs the positions where the first and second surfaces 110 and 111 are to be arranged in the above-described embodiments. However, the inventions are not limited thereto as long as the positional information for relatively adjusting the converging position 161 and the position of the object to be measured 180 is output such that the first and second surfaces 110 and 111 are accommodated within the measurement area 113. For example, a configuration in which the distance between the first surface 110 and the second surface 111 is acquired in advance, and an intermediate position between the first surface 110 and the second surface 111 is output as a position or an area to be arranged, or one of one of the first surface 110 and the second surface 111 is output as the position or the area to be arranged is also applicable.

This application claims the benefit of Japanese Patent Application No. 2014-141807, filed Jul. 9, 2014, and Japanese Patent Application No. 2015-106773, filed May 26, 2015, which are hereby incorporated by reference herein in their entirety.

What is claimed is:

1. A measurement apparatus configured to irradiate an object to be measured with a terahertz wave and measure a time waveform of the terahertz wave reflected from the object to be measured, comprising:
an irradiating unit configured to shape the terahertz wave and irradiate a first surface of the object to be measured and a second surface of the object to be measured with the shaped terahertz wave;
a positional information acquiring unit configured to acquire positional information relating to or on a measurement area of the terahertz wave shaped in the irradiating unit; and
a position adjusting unit configured to relatively adjust a converging position of the terahertz wave shaped in the irradiating unit and a position of the object to be measured in a depth direction of the object to be measured on a basis of the positional information relating to or on the measurement area acquired by the positional information acquiring unit, wherein
the positional information acquiring unit acquires the positional information relating to or on the measurement area by using relationship information indicating a relationship between positions of the first and second surfaces of the object to be measured in the depth direction adjusted by the position adjusting unit and intensities or beam propagation shapes of the terahertz wave, the at least one first pulse and at least one second pulse reflected respectively from the first and second surfaces of the object.

2. The measurement apparatus according to claim 1, further comprising:
a detecting unit configured to detect the terahertz wave from the object,
wherein the relationship information is acquired by acquiring the intensities or beam diameters of the at least one first pulse and the at least one second pulse of the terahertz wave reflected respectively from the first and second surfaces by detecting the at least one first pulse and the at least one second pulse of the terahertz wave reflected respectively from the first and second surfaces with a detecting unit while changing the positions of the first and second surfaces of the object in the depth direction by the position adjusting unit.

3. The measurement apparatus according to claim 1, wherein
the positional information related to or on the measurement area includes an intermediate position between a position where an intensity of the at least one first pulse of the at least one terahertz wave reflected from the first surface becomes a largest intensity in the depth direction and a position where an intensity of the at least one second pulse of the terahertz wave reflected from the second surface becomes a largest intensity in the depth direction, or an intermediate position between a position where a beam diameter of the at least one first pulse of the terahertz wave reflected from the first surface becomes a smallest beam diameter in the depth direction amongst measured or acquired beam diameters and a position where a beam diameter of the at least one second pulse of the terahertz wave reflected from the second surface becomes a smallest beam diameter in the depth direction amongst measured or acquired beam diameters.

4. The measurement apparatus according to claim 1, further comprising:
an accuracy information output unit configured to output at least one of a specified accuracy or conditions for satisfying the specified accuracy as accuracy information, wherein
the positional information acquiring unit acquires a positional information relating to or on the measurement area by using the relationship information and the accuracy information.

5. The measurement apparatus according to claim 4, wherein
the accuracy information output unit outputs a distance between the first surface and the second surface of the object which satisfies the specified accuracy as the accuracy information.

6. The measurement apparatus according to claim 4, wherein
the relationship information is acquired by acquiring the intensities of the at least one first pulse and at least one second pulse of the terahertz wave respectively on the first and second surfaces while changing the positions of the first and second surfaces in the depth direction, and
the positional information acquiring unit acquires a first area in which the intensity of the at least one first pulse of the terahertz wave on the first surface satisfies the accuracy and a second area in which the at least one second pulse of the terahertz wave reflected from the second surface satisfies the accuracy by using the relationship information and the accuracy information, and acquires positional information on the measurement area including positional information on an overlapped area in which the first area and the second area overlap.

7. The measurement apparatus according to claim 6, wherein
the accuracy information output unit outputs a distance between the first surface and the second surface of the object which satisfies the specified accuracy as the accuracy information.

8. The measurement apparatus according to claim 1, wherein
the object to be measured includes a sample and a plate-shaped member configured to support the sample,
the first surface is a surface of the plate-shaped member where the terahertz wave shaped in the irradiating unit reaches first, and
the second surface is a surface opposing the first surface and is a surface where the sample is arranged.

9. The measurement apparatus according to claim 8, further comprising:
a distance adjusting member configured to adjust a thickness of the plate-shaped member.

10. The measurement apparatus according to claim 1, wherein
the object to be measured includes a sample and a plate-shaped member configured to support the sample,
the first surface is a surface of the plate-shaped member where the terahertz wave shaped in the irradiating unit reaches first, and
the second surface is an interface in an interior of the sample arranged on a surface opposing the first surface.

11. The measurement apparatus according to claim 10, further comprising:
a distance adjusting member configured to adjust a thickness of the plate-shaped member.

12. The measurement apparatus according to claim 1, further comprising:
an analyzing unit configured to acquire information on the object to be measured by using the time waveform of the terahertz wave.

13. An imaging apparatus comprising:
the measurement apparatus according to claim 12, and
a position changing unit configured to relatively change a converging position of the terahertz wave shaped in the irradiating unit and a position of the object to be measured in an in-plane direction of the first surface, wherein
an image of a sample included in the object is formed by using information on the object acquired by the analyzing unit.

14. A measuring method configured to irradiate an object to be measured with at least one terahertz wave and measure a time waveform of the terahertz wave reflected from the object to be measured, comprising:
shaping the terahertz wave and irradiating first and second surfaces of the object to be measured with the shaped terahertz wave;
acquiring positional information relating to or on a measurement area of the terahertz wave shaped in the irradiating; and
adjusting relatively a converging position of the terahertz wave shaped in the irradiating and a position of the object to be measured in a depth direction of the object to be measured on a basis of the positional information relating to or on the measurement area acquired by the acquiring, wherein
the acquiring acquires the positional information relating to or on the measurement area by using relationship information indicating a relationship between the positions of the first and second surfaces of the object to be measured in the depth direction and intensities or beam propagation shapes of the terahertz wave, the at least one first pulse and at least one second pulse reflected respectively from the first and second surfaces of the object.

15. The measuring method according to claim 14, further comprising:
irradiating the object to be measured with the terahertz wave in a state in which the converging position of the terahertz wave and the position of the object to be measured are relatively adjusted by the adjusting, and
detecting the at least one first pulse and the at least one second pulse of the terahertz wave radiated in the irradiating and reflected from the object to be measured.

16. The measuring method according to claim 14, further comprising:
acquiring the relationship information by acquiring the intensities or the beam propagation shapes of the at least one first pulse and the at least one second pulse reflected respectively from the first and second surfaces of the object by detecting the at least one first pulse and the at least one second pulse reflected respectively from the first and second surfaces while relatively changing the converging position of the terahertz wave and the position of the object to be measured.

17. The measuring method according to claim 16, further comprising:
irradiating the object to be measured with the terahertz wave in a state in which the converging position of the terahertz wave and the position of the object to be measured are relatively adjusted in the adjusting, and
detecting the at least one first pulse and the at least one second pulse of the terahertz wave radiated in the irradiating and reflected from the object to be measured.
